(19) United States
(12) Patent Application Publication
(10) Pub. No.: US 2007/0033806 A1
(43) Pub. Date: Feb. 15, 2007

(54) Handle for a shaving implement

(75) Inventors: Glennis J. Orloff, Woodbridge, CT (US); David Dombrowski, Madison, CT (US); Christine M. Ciccone, Boston, MA (US); Mark S. Peyser, Easton, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/484,238

(22) Filed: Jul. 10, 2006

Related U.S. Application Data
(60) Provisional application No. 60/698,143, filed on Jul. 11, 2005.

(51) Int. Cl. B26B 19/14

(52) U.S. Cl. 30/43.4

(57) ABSTRACT

According to one aspect of the present invention, a handle for a shaving implement includes a tail portion, a head portion and a neck portion. The tail portion includes a width and a thickness, and defines a centerline when the handle is viewed from a side. The head portion defines a flat surface for supporting a razor cartridge thereon, a thickness and a centerline when the handle is viewed from the side. The neck portion separates the tail portion and the head portion, and defines an angle, a pinch and a thumbprint thickness.

### CROSS REFERENCE TO RELATED APPLICATION

This application claims the benefit of Provisional Patent application Ser. No. 60/698,143, filed July 11, 2005.

### TECHNICAL FIELD

This invention relates to a handle for a shaving implement in general and, more particularly, to an ergonomically designed handle for a shaving implement.

### BACKGROUND INFORMATION

Handles for shaving implements typically include a grip portion, a head portion and neck portion. The head portion of most prior art razors extend from the grip portion of the handle via an angled neck portion. The actual angle at which the neck portion is bent depends upon numerous factors, including, but not limited to, the desired angle between the

The head portion of the handle can take on any one of many shapes and sizes, depending on the type of razor cartridge that is connectable thereto. For example, some handles connect to a razor cartridge, while others connect to a razor cartridge surrounded by a shaving aid body. In the former instance, the head portion often includes a spring loaded plunger that acts to bias the razor cartridge towards a neutral position. In the latter instance, the head portion often includes a self-leveling mechanism which can operate to keep the shaving aid body and the razor cartridge co-planar even though the shaving aid body erodes during use. In some instances, the user holds or braces the shaving implement at least in part by the head portion; therefore, the size and shape of the head is also important to user comfort.

The tail portion of the handle in most prior art razors is substantially cylindrical, with a diameter of approximately 7 mm to about 20 mm. In some instances, the tail portion of prior art handles have been made substantially flat (i.e., rectangular cross-section), or made to have a generally oval cross-section. In addition, the grip portion is often slightly curved, and/or includes grip structures to make the handle less likely to be dropped.

However, the user, when shaving various body parts (e.g., legs, ankles, underarms, face, back, chest, bikini area, etc.), often tends to hold the handle of the shaving implement using various grips (e.g., between his or her thumb and finger tips, in his or her palm, etc.). The stick-like handles that are prevalent in the marketplace are not conducive to being easily held in the various grips necessary to easily and comfortably shave certain body parts. The problem is accentuated when the razor handle becomes wet and/or soapy, and therefore slippery, as well as when the user is shaving an extremity (e.g., back of the legs, ankles) where the user must reach and/or contort him or herself to properly position the shaving implement for shaving the area.

Accordingly, there is a need in the art to overcome a shortcoming in the prior art by providing an ergonomic handle for a shaving implement that can be easily held during the shaving of the various body parts.

### SUMMARY OF THE DISCLOSURE

According to one aspect of the present invention, a handle for a shaving implement includes a tail portion, a head portion and a neck portion. The tail portion includes a width and a thickness, and defines a centerline when the handle is viewed from a side. The head portion defines a flat surface for supporting a razor cartridge thereon, a thickness and a centerline when the handle is viewed from the side. The neck portion separates the tail portion and the head portion, and defines an angle, a pinch and a thumbprint thickness. The angle of the neck is measured between the centerline of the tail portion and the flat surface of the head portion, and is between 40 and 74 degrees. The thickness of the tail portion is between 28.5 mm and 44.5 mm. The width of the tail portion is between 11.7 mm and 21.7 mm. The thickness of the head portion is between 35.2 mm and 40.2 mm. The thumbprint thickness of the neck is between 21.5 mm and 31.5 mm. The pinch of the neck is between 22.5 mm and 34.5 mm. The length of the shaving implement as measured from an end of the head portion to an end of the tail portion in a direction substantially parallel to the centerline of the head portion is between 77.2 mm and 120.0 mm.

One advantage of the present invention is handle is comfortable for users to shave a number of different body parts, using a variety of grips.

This and other advantages of the present invention will be apparent to one of ordinary skill in the art in light of the Detailed Description and Drawings.

### DESCRIPTION OF DRAWINGS

FIG. 1 is a side view of one embodiment of a handle for a shaving implement of the present invention indicating key variable dimensions of the handle;

FIG. 2 is a side view of the handle for a shaving implement of FIG. 1, wherein the handle includes a shaving cartridge mounted thereon;

FIG. 3 is a front view of the handle for a shaving implement of FIG. 1 showing an additional key variable dimension;

FIG. 4 is a isometric view of one embodiment of the present invention;

FIG. 5 is a side view of one embodiments of the present invention; and

FIG. 6 is a front view of one embodiment of the present invention.

### DETAILED DESCRIPTION

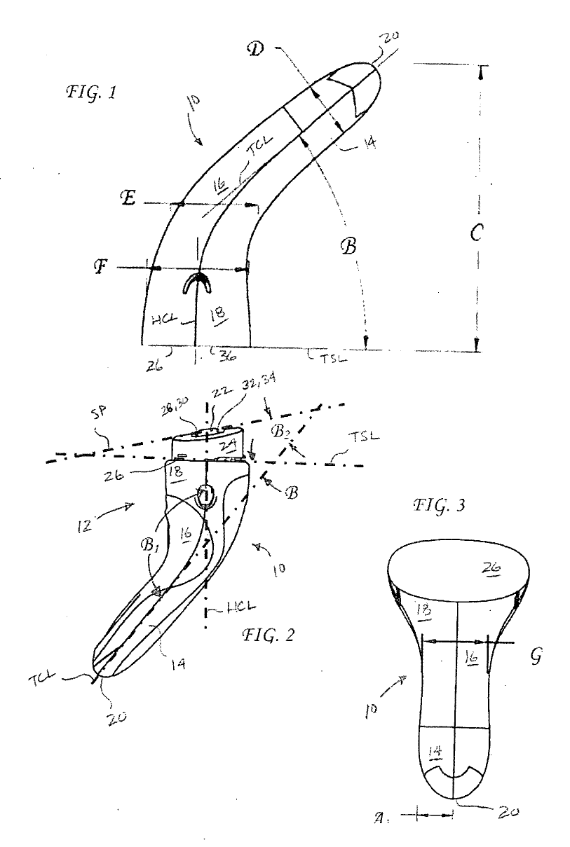

Referring to FIGS. 1-3, a handle 10 for a shaving implement 12 is shown and identified by the numeral 10. The handle 10 includes a tail portion 14, a neck portion 16 and a head portion 18. The neck portion 16 is angled and separates the tail portion 14 from the head portion 18. As indicated in Table 1 below, the handle 10 includes the following seven (7) key variable dimensions: tail width (A), angle of the neck (B), overall length (C), tail thickness (D), thumbprint thickness (E), head thickness (F), and pinch (G). Each of the key variable dimensions is depicted in FIGS. 1-3.

TABLE 1
IDENTIFIERS FOR KEY VARIABLE HANDLE FEATURES

| VARIABLE HANDLE FEATURES | IDENTIFIER |
|---|---|
| Tail Width | A = 2 * A₁ |
| Angle (Centerline of Tail vs. Top Surface) | B |
| Angle (Centerline of Tail vs. Centerline of Head) | B₁ |
| Angle (Centerline of Tail vs. Shave Plane) | B₂ |
| Length | C |
| Tail Thickness | D |
| Thumbprint Thickness | E |
| Head Thickness | F |
| Pinch | G |

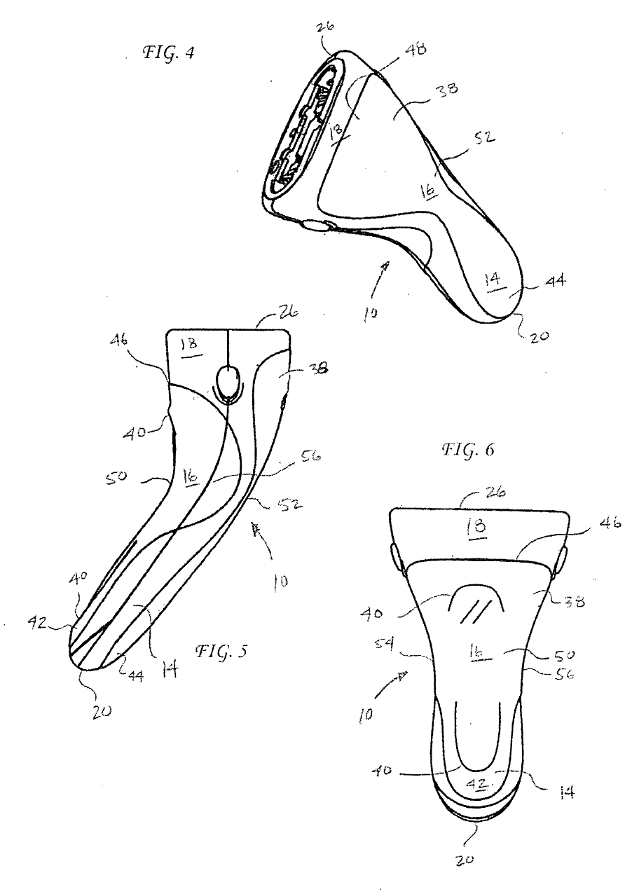

Referring to FIGS. 1, 3 and 4, the tail portion 14 defines a width (A) and a thickness (D). The width (A) is intended to be double the distance indicated by A₁, as shown in FIG. 3. The thickness (D) and width (A) can be substantially uniform along the entire tail portion 14; however, the thickness (D) and width (A) can vary, if desired. For example, as shown in FIGS. 1 and 3, one or both of the dimensions (A,D) can increase slightly from an end 20 of the tail portion 14 towards the neck portion 16. In some embodiments, the width (A) of the tail portion 14 is between 28.5 mm and 44.5 mm and the thickness (D) is between 11.7 mm and 21.7 mm. Preferably the width (A) is approximately 31.8 mm, and the thickness (D) is approximately 21.6 mm. The tail portion 14 also defines a centerline (TCL) that extends through the middle of the tail portion 14, when the handle 10 is viewed from the side, as shown in FIG. 2. The centerline (TCL) of the tail portion 14, as discussed infra, is used, to aid in determining the angle (B, B₁, B₂) of the neck portion. The tail portion 14 is, in some embodiments, such as the one shown in FIG. 4, is rounded for comfort.

The head portion 18 defines a head thickness (F) and a head width (not labeled). The head width is primarily dependent upon the width of the razor cartridge that can be attached to the handle; however, it is desirable that the head width be wide enough to provide a suitable surface against which the user can press during normal shaving. Typically, though, the head portion 18 is rarely grasped on either side, and, therefore, the width was not identified as a key variable dimension. In some embodiments, the head thickness (F) is between 35.2 mm and 40.2 mm. Studies have shown, as discussed infra, that head thicknesses (F) closer to 37.3 mm have particular utility. Like the tail portion 14, and as shown in FIG. 4, the head portion 18 is typically rounded for comfort.

The head portion 18 can also include members (not shown) for removably connecting a razor cartridge 22 or a razor cartridge 22 and a shaving aid body 24 combination (see FIG. 2). However, in some embodiments, the razor cartridge 22 (or razor cartridge 22 and shaving aid body 24 combination) can be coupled to the head portion 18 such that the two are not intended to be separable during normal use. In some instances, such as the embodiments shown in FIGS. 1-3, the head portion 18 provides a substantially flat top surface 26 on which the razor cartridge 22 can sit.

In addition, and now referring to FIG. 2, the head portion 18 defines a centerline (HCL) that extends through the middle of the head portion 18 when the handle 10 is viewed from the side. The centerline (HCL) can be used, in some embodiments, as discussed infra, to define the angle (B₁) of the neck portion 16.

Referring to FIGS. 1 and 2, the neck portion 16 is angled and separates the head portion 18 from the tail portion 14. The neck portion 16 further includes a thumbprint thickness (E), and a pinch (G). The angle (B, B₁, B₂), as shown in FIG. 2, can be measured in several ways. For example, in embodiments where the head portion 18 includes a flat top surface 26, the angle (B) can be measured using the intersection between the centerline (TCL) of the tail portion 14 and a line (TSL) parallel to the top surface 26. Using this method, the angle (B) of the neck portion 16 is preferably between 40 degrees and 74 degrees, with the most preferred angle (B) being approximately 57 degrees.

Another suitable technique for measuring the angle (B₁) of the neck portion 16 is to use the intersection of the centerline (TCL) of the tail portion 14 and the centerline (HCL) of the head portion 18. Using this method, the angle (B₁) of the neck portion 16 is preferably between 130 degrees and 164 degrees. Most preferably, using the intersection of the centerlines (TCL, HCL) of the tail and head portions 14,18, the angle (B₁) of the neck portion 16 is approximately 147 degrees. It is also important to note that although the centerline (HCL) of the head portion 18 is shown to be at a 90 degree angle to the top surface 26 of the head, the present invention is not to be considered so limited.

A further technique for measuring the angle (B₂) of the neck portion 16 is to use the intersection of the centerline (TCL) of the tail portion 14 and the shave plane (SP), as is also shown in FIG. 2. For the purposes of the present invention, the term “shave plane” is intended to refer to a line that extends tangentially from the outermost surface 28 of a guard portion 30 of the razor cartridge 22 to an outmost surface 32 of a cap portion of the razor cartridge 34. Using the above-described method, the neck angle (B₂) is preferably between 30 degrees and 74 degrees, with the most preferable angle (B₂) being 64 degrees. Although the shave plane (SP) is shown as rotated 10 degrees away from the top surface 26 of the head portion 18 (and 80 degrees away from the centerline (HCL) of the head portion 18), the present invention is not to be considered to be so constrained. Rather, these relative positions can vary slightly, depending on the final design of the handle 10.

The thumbprint thickness (E) is preferably between 21.5 mm and 31.5 mm, with 28.7 mm being the most preferable. Likewise, the pinch (G) is preferably between 22.5 and 34.5, with the most preferable being 34.5 mm.

Referring back to FIG. 1, the overall length (C) of the shaving implement is defined by a length (C) from the end 20 of the tail portion 14 to the end 36 of the head portion 18 (e.g., the top surface 26) along a line parallel to the centerline (HCL) of the head portion 18. The length (C) of the handle 10 can vary between approximately 77.2 mm to approximately 120.0 mm, with the preferred length (C) being 110.0 mm.

The first step in designing the handle 10 of the present invention was to identify the key variable dimensions, listed supra in Table 1. Next, the ranges for each key variable dimension were bounded. Any one of numerous methods can be used for bounding the ranges for each key variable dimension. Various methods of determining the preferred embodiment of the present invention could have been used. In the present instance, the bounds of each key variable were determined using various criteria (e.g., feedback from test shaves, size requirements for consumer sales, etc.).

In order to determine the most preferred set of key variable dimensions, again, several techniques can be used. For example, hundreds of models could be built and tested to determine which was most liked by users. However, predictive software enabled designers to reduce the number of test handles significantly by predicting a number sample handles by using a limited amount of known data. In the present case, predictive software provided fourteen (14) different handles that fell within the ranges defined supra. The fourteen (14) samples are provided below in Table 2. Note: two (2) samples (i.e., samples 1 and 10) were repeated to ensure that consistent results were consistent, rendering sixteen (16) test samples in all.

TABLE 2
KEY VARIABLE DIMENSIONS FOR TEST SAMPLES

| | | B/B₁/B₂ | | | | F | G |
|---|---|---|---|---|---|---|---|
| Sample | A (mm) | (deg) | C (mm) | D (mm) | E (mm) | (mm) | (mm) |
| 1* | 28.5 | 40/130/30 | 97.2 | 21.7 | 31.5 | 35.2 | 34.5 |
| 2 | 44.5 | 40/130/30 | 97.2 | 11.7 | 21.5 | 40.2 | 34.5 |
| 3 | 28.5 | 74/164/64 | 97.2 | 21.7 | 21.5 | 40.2 | 22.5 |
| 4 | 44.5 | 40/130/30 | 77.2 | 21.7 | 21.5 | 35.2 | 22.5 |
| 5 | 28.5 | 40/130/30 | 77.2 | 21.7 | 21.5 | 40.2 | 34.5 |
| 6 | 44.5 | 74/164/64 | 97.2 | 11.7 | 31.5 | 35.2 | 22.5 |
| 7 | 28.5 | 40/130/30 | 77.2 | 11.7 | 31.5 | 40.2 | 22.5 |
| 8 | 44.5 | 74/164/64 | 77.2 | 21.7 | 31.5 | 40.2 | 34.5 |
| 9 | 28.5 | 74/164/64 | 77.2 | 21.7 | 31.5 | 35.2 | 22.5 |
| 10** | 28.5 | 74/164/64 | 77.2 | 11.7 | 21.5 | 35.2 | 34.5 |
| 11* | 28.5 | 40/130/30 | 97.2 | 21.7 | 31.5 | 35.2 | 34.5 |
| 12 | 36.5 | 57/147/47 | 87.2 | 11.7 | 26.5 | 37.7 | 28.5 |
| 13 | 37.5 | 54/144/44 | 87.2 | 16.7 | 26.5 | 37.7 | 28.5 |
| 14 | 36.5 | 57/147/47 | 97.2 | 16.7 | 26.5 | 37.7 | 28.5 |
| 15** | 28.5 | 74/164/64 | 77.2 | 11.7 | 21.5 | 35.2 | 34.5 |
| 16 | 36.5 | 74/164/64 | 87.2 | 16.7 | 26.5 | 37.7 | 28.5 |

The test samples were then manufactured and tested in human shave tests. The tested were each requested to use several of the samples, and fill out the questionnaire in Table 3 for each one. The questions asked the testers to rate the test handles based on their experiences and impressions gained while shaving various body parts (e.g., legs, knee, ankles, and underarms).

TABLE 3
QUESTIONS POSED TO TEST SUBJECTS

| Symbol | Questionnaire Category |
|---|---|
| Q1 | Rating for “How much did you like this razor handle overall for shaving legs?” |
| | (9 [Like it Extremely] to 1 [Dislike it Extremely]) |
| Q2 | Rating for “How suitable is the handle for shaving the ankle area?” |
| | (7 [Very Suitable] to 1 [Very Unsuitable]) |
| Q3 | Rating for “How suitable is the handle for shaving the knee area?” |
| | (7 [Very Suitable] to 1 [Very Unsuitable]) |
| Q4 | Rating for “How easy or difficult was it to Control the Movement of ths |
| | product while shaving your legs?” |
| | (7 [Very Easy] to 1 [Very Difficult]) |
| Q5 | Rating for “How easy or difficult was it to Maneuver Around Difficult |
| | Areas while shaving your legs?” |
| | (7 [Very Easy] to 1 [Very Difficult]) |
| Q6 | Rating for “Would you say that this particular handle Was Comfortable |
| | To Hold while shaving your legs?” |
| | (7 [Very Comfortable] to 1 [Very Uncomfortable]) |
| Q7 | Rating for “Again, focusing on this particular handle, would you say |
| | that it Felt Good In Your Hand?” |
| | (7 [Agree Strongly] to 1 [Disagree Strongly]) |
| Q8 | Rating for “How much did you like this razor handle overall for shaving |
| | underarms?” |
| | (9 [Like it Extremely] to 1 [Dislike it Extremely]) |
| Q9 | Rating for “How easy or difficult was it to Control the Movement of this |
| | product while shaving your underarms?” |
| | (7 [Very Easy] to 1 [Very Difficult]) |
| Q10 | Rating for “How easy or difficult was it to Maneuver Around Difficult |
| | Areas while shaving your Underarms?” |
| | (7 [Very Easy] to 1 [Very Difficult]) |
| Q11 | Rating for “Would you say that this particular handle Was Comfortable |
| | To Hold while shaving your underarms?” |
| | (7 [Very Comfortable] to 1 [Very Uncomfortable]) |
| Q12 | Rating for “Again, focusing on this particular handle, would you say |
| | that it Felt Good In Your Hand while shaving your underarms?” |
| | (7 [Agree Strongly] to 1 [Disagree Strongly]) |
| Q13 | Rating for “Imagine using this handle to shave your bikini area. Would |
| | you say that this handle would make Shaving Your Bikini Area easier?” |
| | (7 [Agree Strongly] to 1 [Disagree Strongly]) |
| Q14 | Rating for “Please think about shaving your legs, underarms, and bikini |
| | area. Taking all things into consideration, would you say that this |
| | handle Performed Well Overall?” |
| | (7 [Agree Strongly] to 1 [Disagree Strongly]) |

The results of the data received from the test subjects was compiled and averaged, as follows in Table 4.

TABLE 4
AVERAGED RESULTS FROM SHAVE TESTS

| Sample | Q1 | Q2 | Q3 | Q4 | Q5 | Q6 | Q7 | Q8 | Q9 | Q10 | Q11 | Q12 | Q13 | Q14 |
|---|---|---|---|---|---|---|---|---|---|---|---|---|---|---|
| 1* | 7.25 | 5.75 | 5.74 | 5.77 | 5.65 | 5.70 | 5.73 | 7.36 | 5.78 | 5.76 | 5.78 | 5.79 | 5.16 | 5.59 |
| 2 | 6.86 | 5.47 | 5.50 | 5.63 | 5.43 | 5.35 | 5.37 | 6.89 | 5.58 | 5.48 | 5.35 | 5.30 | 4.71 | 5.28 |
| 3 | 6.43 | 5.18 | 5.10 | 5.27 | 5.12 | 5.04 | 4.99 | 6.64 | 5.29 | 5.21 | 5.22 | 5.20 | 4.82 | 5.00 |
| 4 | 6.04 | 5.02 | 5.06 | 4.97 | 4.76 | 4.57 | 4.48 | 6.28 | 5.02 | 4.98 | 4.73 | 4.70 | 4.58 | 4.78 |
| 5 | 5.48 | 4.43 | 4.58 | 4.40 | 4.35 | 4.09 | 4.05 | 5.58 | 4.53 | 4.38 | 4.30 | 4.25 | 4.19 | 4.18 |
| 6 | 4.83 | 3.97 | 4.01 | 4.01 | 3.90 | 3.58 | 3.58 | 5.09 | 4.13 | 4.08 | 3.76 | 3.66 | 3.53 | 3.63 |
| 7 | 4.48 | 3.70 | 3.91 | 3.76 | 3.61 | 3.27 | 3.28 | 4.73 | 3.79 | 3.77 | 3.53 | 3.55 | 3.35 | 3.38 |
| 8 | 4.26 | 3.57 | 3.62 | 3.63 | 3.53 | 3.26 | 3.18 | 4.73 | 3.91 | 3.84 | 3.64 | 3.59 | 3.34 | 3.33 |
| 9 | 3.66 | 3.27 | 3.36 | 3.13 | 3.22 | 2.73 | 2.78 | 4.01 | 3.31 | 3.31 | 3.06 | 2.89 | 2.93 | 2.78 |
| 10** | 3.18 | 3.03 | 2.99 | 2.77 | 2.81 | 2.43 | 2.33 | 3.67 | 3.12 | 3.09 | 2.78 | 2.78 | 2.61 | 2.56 |
| 11* | 7.25 | 5.74 | 5.84 | 5.75 | 5.73 | 5.80 | 5.78 | 7.37 | 5.71 | 5.60 | 5.76 | 5.71 | 5.21 | 5.68 |
| 12 | 5.75 | 4.76 | 4.79 | 4.84 | 4.73 | 4.53 | 4.43 | 6.01 | 4.87 | 4.86 | 4.77 | 4.68 | 4.33 | 4.49 |
| 13 | 6.50 | 5.24 | 5.31 | 5.34 | 5.21 | 4.99 | 4.91 | 6.51 | 5.36 | 5.30 | 5.24 | 5.22 | 4.59 | 4.95 |
| 14 | 7.30 | 5.76 | 5.83 | 5.95 | 5.73 | 5.95 | 6.01 | 7.52 | 5.94 | 5.86 | 5.93 | 5.92 | 5.28 | 5.82 |
| 15** | 2.91 | 2.63 | 2.82 | 2.42 | 2.58 | 1.98 | 2.04 | 3.14 | 2.76 | 2.78 | 2.42 | 2.30 | 2.58 | 2.16 |
| 16 | 5.04 | 4.05 | 4.22 | 4.18 | 4.08 | 3.80 | 3.68 | 5.23 | 4.38 | 4.28 | 4.02 | 4.10 | 3.87 | 3.80 |

The duplicated samples, especially samples 1 and 10, tend to indicate the accuracy of the results, and the grayed samples (i.e., samples 1, 11 and 14) were deemed to be the most well-liked. Accordingly, the preferred embodiment was designed, as shown in Table 5, using knowledge gained from the test and computer modeling.

TABLE 5
KEY DIMENSIONS FOR PREFERRED EMBODIMENT

| | | B/B₁/B₂ | | D | E | F | G |
|---|---|---|---|---|---|---|---|
| — | A (mm) | (deg) | C (mm) | (mm) | (mm) | (mm) | (mm) |
| Preferred | 31.8 | 54/144/44 | 110.0 | 21.6 | 28.7 | 37.3 | 34.5 |
| Embodiment | | | | | | | |

In addition, and referring to FIGS. 4-6, the handle 10 can include additional features, such as non-skid grips 38 in key locations and indentations 40, which aid the user in maintaining a proper grip on the handle 10 during use. Specifically, the non-skid grips 38, which can be made of any suitable material (e.g., elastomeric material), are located on the front 42 and back 44 of the tail portion 14, on the front 46 and back 48 of the head portion 18, and on the front 50, back 52 and either side 54,56 of the neck portion 16. Indentations 40 are provided on the front 50 of the neck portion 16, and on the front 42 of the tail portion 14. Both types of features 38,40 aid the user in grasping the handle in the most common methods. These methods include placing the handle 10 in the palm, with the thumb on the front of the neck portion 16 and the fingers splayed across the back of the head portion 18 and neck portion 16. Alternatively, the user can hold the handle 10 outside of the palm, with the thumb on the front 50 of the neck portion 16 and, typically, two (2) or three (3) fingers on the back 48 of the head portion 18. And, finally, the user can hold the tail portion 14 of the handle 10 by placing the thumb on the front 42 of the tail portion 14 and, typically, two (2) to three (3) fingers on the back 44 of the tail portion 14. Naturally, there are many additional ways for holding the handle 10, as the above methods are simply exemplary.

Modifications and variations may be made to the above disclosure without departing from the spirit and scope of the present invention.

What is claimed is:

1. A handle for a shaving implement, comprising:
a tail portion having a width and a thickness and defining a centerline when the handle is viewed from a side;
a head portion defines a flat surface for supporting a razor cartridge thereon, a thickness and a centerline when the handle is viewed from the side; and
a neck portion separating the tail portion and the head portion, wherein the neck defines an angle, a pinch and a thumbprint thickness;
wherein the angle is measured between the centerline of the tail portion and the flat surface of the head portion, and wherein the angle is between 40 and 74 degrees;
wherein the thickness of the tail portion is between 28.5 mm and 44.5 mm;
wherein the width of the tail portion is between 11.7 mm and 21.7 mm;
wherein the thickness of the head portion is between 35.2 mm and 40.2 mm;
wherein the thumbprint thickness of the neck is between 21.5 mm and 31.5 mm;
wherein the pinch of the neck is between 22.5 mm and 34.5 mm; and
wherein the length of the shaving implement as measured from an end of the head portion to an end of the tail portion in a direction substantially parallel to the centerline of the head portion is between 77.2 mm and 120.0 mm.

2. The shaving implement of claim 1, wherein the angle is approximately 54 degrees.

3. The shaving implement of claim 1, wherein the thickness of the tail portion is between approximately 21.6 mm.

4. The shaving implement of claim 1, wherein the width of the tail portion is approximately 31.8 mm.

5. The shaving implement of claim 1, wherein the thickness of the head portion is approximately 37.3 mm.

6. The shaving implement of claim 1, wherein the thumbprint thickness of the neck is approximately 28.7 mm.

7. The shaving implement of claim 1, wherein the pinch of the neck is approximately 34.5 mm.

8. The shaving implement of claim 1, wherein the length of the shaving implement is approximately 110.0 mm.

9. The shaving implement of claim 1, wherein a front and a back of the tail portion includes non-skid grips.

10. The shaving implement of claim 9, wherein the front of the tail portion further includes an indentation.

11. The shaving implement of claim 1, wherein a front and a back of the neck portion includes non-skid grips.

12. The shaving implement of claim 11, wherein the front of the neck portion includes an indentation.

13. The shaving implement of claim 1, wherein each side of the neck portion includes non-skid grips.

14. The shaving implement of claim 1, wherein a front and a back of the head portion includes non-skid grips.

15. A handle for a shaving implement, comprising:
a tail portion having a width and a thickness and defining a centerline when the handle is viewed from a side;
a head portion defines a thickness and a centerline when the handle is viewed from the side; and
a neck portion separating the tail portion and the head portion, wherein the neck defines an angle, a pinch and a thumbprint thickness;
wherein the angle is measured between the centerline of the tail portion and the centerline of the head portion, and wherein the angle is between 130 and 164 degrees;
wherein the thickness of the tail portion is between 28.5 mm and 44.5 mm;
wherein the width of the tail portion is between 11.7 mm and 21.7 mm;
wherein the thickness of the head portion is between 35.2 mm and 40.2 mm;
wherein the thumbprint thickness of the neck is between 21.5 mm and 31.5 mm;
wherein the pinch of the neck is between 22.5 mm and 34.5 mm; and
wherein the length of the shaving implement as measured from an end of the head portion to an end of the tail portion in a direction substantially parallel to the centerline of the head portion is between 77.2 mm and 120.0 mm.

16. A handle for a shaving implement, comprising:
a tail portion having width and a thickness and defining a centerline when the handle is viewed from a side;
a head portion defines a thickness and a centerline when the handle is viewed from the side; and
a neck portion separating the tail portion and the head portion, wherein the neck defines an angle, a pinch and a thumbprint thickness;
wherein the angle is measured between the centerline of the tail portion and a shave plane of a razor cartridge attached to the handle, and wherein the angle is between 30 degrees and 64 degrees;
wherein the thickness of the tail portion is between 28.5 mm and 44.5 mm;
wherein the width of the tail portion is between 11.7 mm and 21.7 mm;
wherein the thickness of the head portion is between 35.2 mm and 40.2 mm;
wherein the thumbprint thickness of the neck is between 21.5 mm and 31.5 mm;
wherein the pinch of the neck is between 22.5 mm and 34.5 mm; and
wherein the length of the shaving implement as measured from an end of the head portion to an end of the tail portion in a direction substantially parallel to the centerline of the head portion is between 77.2 mm and 120.0 mm.
